(19) United States
(12) Patent Application Publication
(10) Pub. No.: US 2011/0151207 A1
(43) Pub. Date: Jun. 23, 2011

(54) DIE ADHESIVE FILM, REEL FOR DIE ADHESIVE FILM, MOUNTING APPARATUS AND ELECTRONIC DEVICE COMPRISING THE SAME

(76) Inventors: Yong Woo HONG, Uiwang-si (KR); Duck Su Lee, Uiwang-si (KR); Sang Jin Choi, Uiwang-si (KR); Dae Young Hong, Uiwang-si (KR)

(21) Appl. No.: 12/969,986

(22) Filed: Dec. 16, 2010

(30) Foreign Application Priority Data
Dec. 16, 2009 (KR) 10-2009-0125554

(51) Int. Cl. B32B 7/14; B32B 37/02; B32B 37/12; B32B 37/14; B32B 41/00; B32B 38/10; C09J 7/02

(52) U.S. Cl. 428/198; 156/363; 156/378

(57) ABSTRACT

A die adhesive film includes a base film and an end point detection film. The base film includes bonding portions. The bonding portions are arranged in a series on the base film and are capable of being bonded to surfaces of the wafers. The end point detection film includes an end connected to the base film and has at least one end point mark for indicating an end point of the bonding portions on the base film at which the series of bonding portions on the base film is finished.

### BACKGROUND

1. Field

Embodiments relates to a semiconductor device, a die adhesive film (DAF), a reel for winding and supplying the die adhesive film, an electronic device comprising the die adhesive film, and an apparatus for mounting a wafer on the die adhesive using the same.

2. Description of the Related Art

During a wafer dicing process for sawing a semiconductor wafer into individual chips, a die adhesive film may be attached to a surface of a semiconductor wafer to secure the wafer. The die adhesive film may have various structures, e.g., the die adhesive film may include a dicing film and an adhesive film acting as an adhesive layer. A wafer may be attached to the adhesive layer of the die adhesive film, and the dicing film may be bonded to the adhesive layer.

### SUMMARY

Embodiments are directed toward a die adhesive film, a reel for a die adhesive film, a mounting apparatus and electronic device comprising the same. Embodiments may be realized by providing a die adhesive film for bonding to wafers that may include a base film including bonding portions, the bonding portions being arranged in a series on the base film and being capable of being bonded to surfaces of the wafers, and an end point detection film including an end connected to the base film and having at least one end point mark for indicating an end point of the bonding portions on the base film at which the series of bonding portions on the base film is finished.

Embodiments may also be realized by providing a reel for die adhesive films used for bonding to wafers. The die adhesive film may include a base film and an end point detection film. The reel for a die adhesive film may include a reel body having the die adhesive film wound thereon and a mark detector configured to detect at least one end point mark of the end point detection film. The base film includes bonding portions, the bonding portions being arranged in a series on the base film and being capable of being bonded to surfaces of the wafers. The end point detection film includes an end connected to the base film and has at least one end point mark for indicating an end point of the bonding portions on the base film at which the series of bonding portions on the base film is finished. The mark detector is configured to recognize the end point of the bonding portions.

Embodiments may also be realized by providing a mounting apparatus that may include a die adhesive film, a reel for the die adhesive film, and a wafer supply unit. The base film includes bonding portions, the bonding portions being arranged in a series on the base film and being capable of being bonded to surfaces of wafers. The end point detection film includes an end connected to the base film and has at least one end point mark for indicating an end point of the bonding portions on the base film at which the series of bonding portions on the base film is finished. The reel includes a reel body having the die adhesive film wound thereon, and a mark detector configured to detect the at least one end point mark of the end point detection film and to recognize the end point of the bonding portions. The wafer supply unit is configured to sequentially supply the wafers to be bonded to each of the bonding portions of the die adhesive film released and fed from the reel body, the wafer supply unit being configured to stop the supply of the wafers in response to a signal from the mark detector detecting the end point of the bonding portions.

Further, embodiments may also be realized by providing an electronic product that may include an electronic device and a die adhesive film. The die adhesive film including a base film including bonding portions, the bonding portions being arranged in a series on the base film and being capable of being bonded to surfaces of the wafers, and an end point detection film including an end connected to the base film and having at least one end point mark for indicating an end point of the bonding portions on the base film at which the series of bonding portions on the base film is finished.

The bonding portions may include an adhesive film attached to the base film, the adhesive film being capable of being bonded to the surface of the corresponding wafer. A dicing film may be disposed on the adhesive film, the dicing film being configured to have attached thereto a ring frame on a rim of the wafer bonded to the adhesive film.

The end point mark may include a first mark pattern located near a portion of the transparent matrix film connected to the base film; and a second mark pattern separated a predetermined distance behind the first mark pattern and located near a centerline of the transparent matrix film. The end point detection film may include a transparent matrix film, and the at least one end point mark being printed on the transparent matrix film and being an opaque pattern, a pattern having a different chromaticity from the transparent matrix film, or a pattern having a different color from the transparent matrix film. The at least one end point mark may include a first mark pattern adjacent to a portion of the transparent matrix film connected to the base film, and a second mark pattern spaced apart by a predetermined distance from the first mark pattern and disposed near a centerline of the transparent matrix film. The at least one end point mark may be a pattern of continuous or discontinuous bands having a constant width and biased toward an edge of the transparent matrix film, or the at least one end point mark may be a pattern of continuous or discontinuous bands having a same width as the transparent matrix film.

The mark detector may include a photo sensor configured to detect the end point of the bonding portions based on a difference between a first light transmission intensity at the second mark pattern and a second light transmission intensity at a portion of the transparent matrix film following the second mark pattern. The mark detector may include a photo sensor coupled to the reel body, the photo sensor having a light emitting part and a light receiving part configured to detect a difference in light transmission intensity between the at least one end point mark and a portion of the end point detection film adjacent to the end point mark. The light receiving part may be configured to generate a preparatory signal when a first difference in light transmission intensity between a first end point mark and a portion of the end point detection film adjacent to the first end point mark is detected. The light receiving part may be configured to generate a stop wafer supply signal when a second difference in light transmission intensity between a second end point mark and a portion of the end point detection film adjacent to the second end point mark is detected.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a die adhesive film and a reel in accordance with an exemplary embodiment;

FIG. 2 illustrates a die adhesive film in accordance with an exemplary embodiment;

FIG. 3 illustrates a wafer mounting apparatus including the die adhesive film and the reel in accordance with an exemplary embodiment;

FIG. 4 illustrates a die adhesive film in accordance with an exemplary embodiment;

FIGS. 5 and 6 illustrate a process of detecting an end point where bonding portions of the die adhesive film are exhausted in accordance with an exemplary embodiment;

FIGS. 7 to 11 illustrate a process of supplying the die adhesive film in accordance with an exemplary embodiment;

FIG. 12 illustrates an exemplary end point on an end point detection film in accordance with an exemplary embodiment; and

FIG. 13 illustrates an exemplary end point on the end point detection film in accordance with an exemplary embodiment.

### DETAILED DESCRIPTION

Korean Patent Application No. 10-2009-0125554, filed on Dec. 16, 2009, in the Korean Intellectual Property Office, and entitled: “Die Adhesive Film, Reel for Die Adhesive Film, Mounting Apparatus and Electronic Device Comprising the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

A die adhesive film may have a multi-layer structure. For example, a die adhesive film may have a double-layer structure formed, e.g., by laminating a dicing film and an adhesive film. The adhesive layer may act as an adhesive layer to which the wafer may be later attached. The dicing film may be a sticky film including, e.g., a photo-curable resin. The adhesive film applied or bonded to a surface of the dicing film, and the adhesive film may secure the wafer to support the wafer during, e.g., a dicing process. The die adhesive film may have a triple-layer structure formed, e.g., by attaching a band-shaped base film to a surface of the adhesive film on the dicing film. The die adhesive film may include bonding portions that are arranged in series, e.g., on the band-shaped base film. Each bonding portion may be composed of at least the adhesive film on the die adhesive film and the dicing film on the adhesive film.

The die adhesive film may be consecutively fed to a mounting position where the die adhesive film is to be bonded to wafers. Simultaneously the wafers may be sequentially supplied to positions for the wafers on the die adhesive film, and the wafers may be bonded to the adhesive film of the die adhesive film. According to an exemplary embodiment, in order to allow the wafers and the adhesive film to be bonded to each other, the base film of the die adhesive film may be previously separated from the adhesive film. As such, the wafers may be attached to portions of the adhesive film exposed by the separation of the base film from the adhesive film. A ring frame may be attached to a portion of the dicing film exposed to a lateral side of the adhesive film. The die adhesive film may be wound around a reel, and during consecutive feeding to the mounting position the die adhesive film may be released from the reel. The wafers may be sequentially provided to the mounting position and bonded to the die adhesive film fed from the reel.

According to an exemplary embodiment, a die adhesive film may include bonding portions and may including an end point mark for indicating an end point of the bonding portions, e.g., indicating that the bonding portions on the die adhesive film are finished. An exemplary embodiment includes a reel that has an end point detection function to stop the supply of wafers, e.g., based on a detection of a time point to stop feeding the die adhesive film due to exhaustion of the die adhesive film wound around the reel. An end point detection film having an end point mark printed thereon may be connected to the die adhesive film.

A photo sensor may be attached to a reel body of the reel to act as a mark detector for recognizing the end point mark. Such that, e.g., when the die adhesive film is released from the reel body and fed to the mounting position where the wafers are to be mounted on the die adhesive film, an end point of the die adhesive film indicating the exhaustion of the die adhesive film can be detected. The photo sensor may detect a difference in light transmission degree and/or intensity between, e.g., the end point mark and a matrix film of the end point detection film. According to an exemplary embodiment, if any difference is detected by the photo sensor, an end point detection signal may be generated and sent to a wafer supply unit to stop the supply of wafers. Accordingly, it is possible to reduce and/or prevent damage of the wafers. Further, it is possible to reduce and/or prevent damage or defects of a mounting apparatus by preventing the wafers from being supplied after the die adhesive film is exhausted.

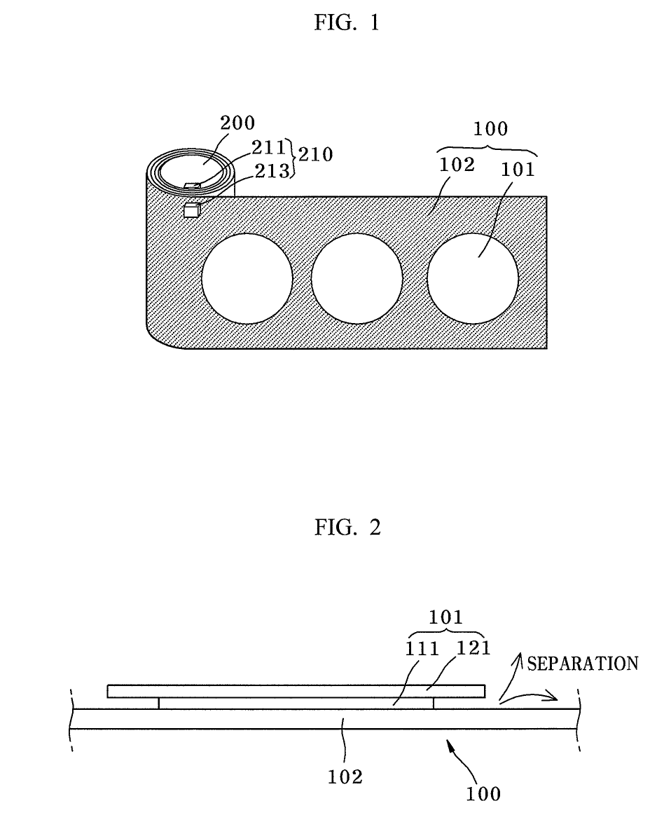

Referring to FIGS. 1 and 2, a die adhesive film 100 according to an embodiment may have a dicing die bonding film structure. For example, the die adhesive film 100 may include a base film 102 and bonding portions 101 arranged in series on the base film 102. The bonding portions 101 may be adapted to be attached to surfaces of wafers. The base film 102 may be formed of a transparent or non-transparent material. For example, the base film 102 may be a transparent polyethylene terephthalate (PET) film. Each of the bonding portions 101 may be composed of an adhesive film 111 to be attached to the wafer surface and a dicing film 121. The dicing film may be a sticky film, e.g., formed of a photo-curable resin, and may secure the wafer to support the wafer during a dicing process. When the base film 102 is stripped off the adhesive film 111, a surface of the adhesive film 111 may be exposed and may allow the wafer to be attached thereto. The dicing film 121 may be adhered to a dicing table, on which a layer dicing process may be performed. A ring frame (not shown) may be attached to an edge of the dicing film 121, e.g., the ring frame may be attached to an edge of the dicing film 121 that does not overlap the adhesive film 111. The ring frame may expose the adhesive film 111, e.g., the ring frame may expose a lateral side of the adhesive film 111.

The base film 102 may be a protection cover or a handling film that is wound around the reel. According to an exemplary embodiment, the die adhesive film 100 may have a dicing film structure instead of a dicing die bonding film structure as described above, e.g., the film may include the dicing film 121 and the base film base film 102. Further, the die adhesive film 100 may include more than three layers.

Referring to FIG. 2, the die adhesive film 100, which includes, e.g., the base film 102 and the bonding portions 101, may be wound around a reel body 200 into a reel. On the die adhesive film 100, the bonding portions 101, each of which may have a shape corresponding to the wafer, are arranged in series in the longitudinal direction of the die adhesive film 100. The shape of the bonding portions 101 is not particularly limited, and the bonding portions 101 may have, e.g., a circular shape, a rectangular shape, a square shape, etc. The bonding portions 101 may be bonded to the wafers in a bonding process, while the die adhesive film 100 is released from the reel body 200.

The reel body 200 may be provided with a photo sensor 210 that acts as a mark detector for detecting the end point mark, e.g., of the end point detection film, to recognize the end point of the bonding portions. The end point of the bonding portions may be where an arrangement of the bonding portions 101 on the die adhesive film 100 is finished. The photo sensor 210 may include a light receiving part 211 for receiving detection light, and may include a light emitting part 213 for emitting and irradiating the detection light.

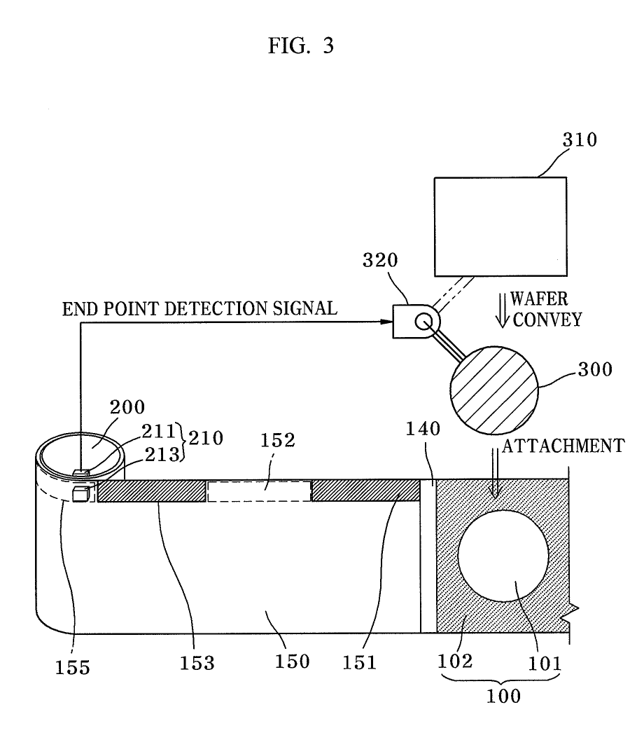

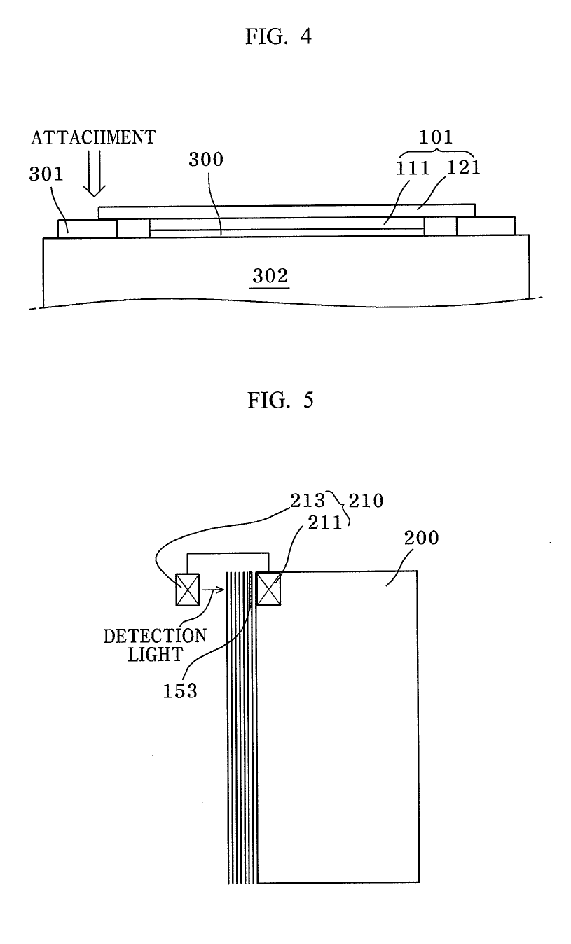

Referring to FIGS. 3 and 4, the die adhesive film 100 may be provided with an end point detection film 150 in order to, e.g., detect the end point of the die adhesive film where the bonding portions 101 of the die adhesive film 100 is exhausted. The end point detection film 150 may be connected to one end of the die adhesive film 100. For example, the end point detection film 150 may be attached to the end of the die adhesive film 100, such that the end point detection film is closer to the reel body 200 than the die adhesive film 100 when the die adhesive film 100 is wound around the reel body. The end point detection film 150 may be connected to the one end of the base film 102 of the die adhesive film 100 by, e.g., an adhesive tape 140. The end point detection film 150 may be made of, e.g., a transparent matrix film. The end point detection film 150 may include end point marks 151 and 153. The end point marks 151, 153 may be formed on the end point detection film 150, and each of the end point marks 151 and 153 may have different degrees of light transmittance than the end point detection film 150.

According to an exemplary embodiment, the end point detection film 150 may be formed of a transparent polymer film such as PET, and the end point marks 151, 153 may be composed of a mark pattern printed on the end point detection film 150. The end point marks 151, 153 may have different configurations, e.g., may have different colors or chromaticity, as compared to the reel body 200. For example, when the reel body 200 has a green or pink color, the end point marks 151, 153 may have a pink or green color that has a different chromaticity than the reel body. The end point marks 151, 153 may have a different color than the reel body 200, e.g., when the reel body 200 has a green color the end point marks 151, 153 may have a green color.

Referring to FIG. 3, in an exemplary embodiment, the die adhesive film 100 may be fed to the mounting position, and wafers 300 may be supplied to the mounting position from a wafer supply unit 320. At the mounting position, the wafers 300 may be mounted on the die adhesive film. The photo sensor 210 may be configured to detect the end point marks 151, 153 when the bonding portions of the die adhesive film 100 are finished. The photo sensor 210 may be configured to send an end point detection signal to the wafer supply unit 320 to indicate that the arrangement of the bonding portions 101 of the die adhesive film 100 is finished. The end point detection signal may indicate that the wafer supply unit 310 should stop providing wafers to the mounting position.

According to an exemplary embodiment, a robot arm acting as the wafer supply unit 320 may supply the wafers 300 to a mounting table 320 (see FIG. 4), on which the bonding portions 101 are attached to the wafers 300. When the wafer 300 is supplied to the mounting table 320, a front side of the wafer 300 with a circuit pattern formed thereon may be disposed to face a surface of the table 302, and a ring frame 301 may be mounted around a rim of the wafer 300. While being released from the reel body 200, the base film 102 and the bonding portions 101 of the die adhesive film 100 may be separated from each other, so that the exposed adhesive film 111 of the bonding portion 101 may be attached to a rear side of the wafer 300. The rear side of the wafer 300 may oppose the front side of the water that includes the circuit pattern. At the mounting table 320, the edge of the dicing film 121 exposed to the lateral side of the adhesive film 111 may be attached to the ring frame 301. After the adhesive film 111 and the dicing film 121 of the die adhesive film 100 are attached to the wafer 300, the wafer 300 may be conveyed to a dicing process unit and subjected to additional processing, e.g., sawing, chip pick-up, and the like.

Referring again to FIG. 3, the wafer supply unit 320 may sequential supply the wafers 300 stored in a wafer storage 310, e.g., such as a cassette, to the bonding portions 101 of the die adhesive film 100, thereby the bonding portions 101 may be attached to the surfaces of the wafers 300. Upon receiving the end point detection signal from, e.g., the photo sensor 210, the wafer supply unit 320 may stop the supply of the wafers 300. Accordingly, it is possible to prevent an additional supply of the wafers 300 when the bonding portions 101 of the die adhesive film 100 are exhausted.

According to an exemplary embodiment, in order to detect the end point where the bonding portions 101 of the die adhesive film 100 are exhausted, the end point detection film 150 may be connected at one end thereof to the end of the base film 102. Another end of the end point detection film 150 may be connected at the to the reel body 210. In this state, the end point detection film 150 and the die adhesive film 100 may be sequentially wound around the reel body 200. Thus, after the die adhesive film 100 is completely released from the reel body 200, the end point detection film 150 may be released from the reel body 200. Thus, the end point marks 151, 153 on the end point detection film 150 may be exposed.

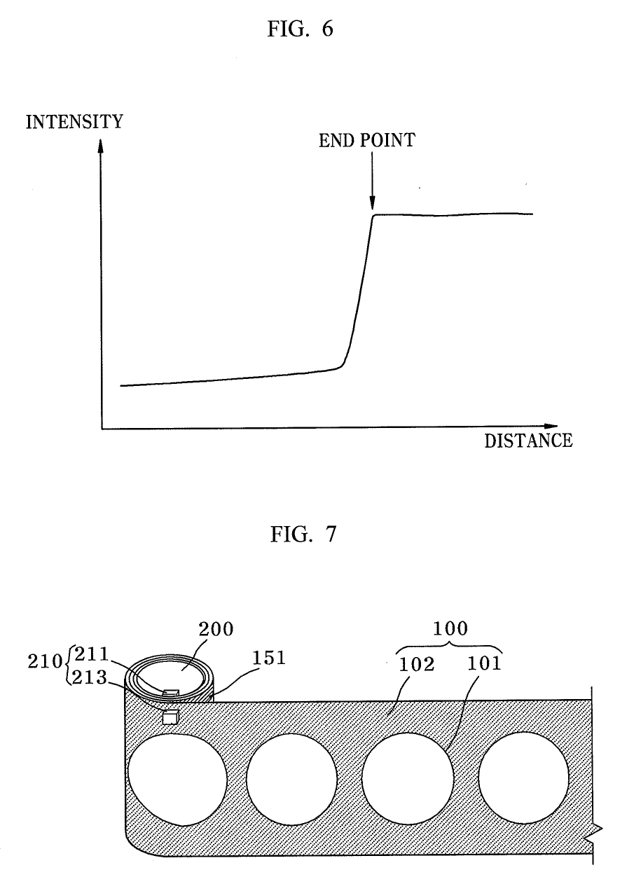

FIGS. 5 and 6 show a process of detecting the end point when the bonding portions of the die adhesive film according to the embodiment are exhausted. Referring to FIGS. 5 and 6, the photo sensor 210 may be attached to the reel body 200, and the photo sensor 210 may detect a difference in light transmission degree and/or intensity between the end point marks 151, 153 and a portion of the transparent matrix film of the end point detection film 150 adjacent to the end point marks 151, 153. The photo sensor 210 and/or the light receiving part 211 and light emitting part 213 of the photo sensor 210 may be disposed at portions of the reel body 200 corresponding to the end point marks 151, 153. Referring to FIG. 5, when the end point detection film 150 is not released from the reel body 200 or the bonding portions 101 and base film 202 of the die adhesive film 100 are wound around the reel body 200, the end point marks 151, 153 may be wound around the reel body 200. As shown in FIG. 6, when the end point marks 151, 153 are not detected, the intensity of light detected by the photo sensor 210 may be maintained in a low state. For example, the reel body 200 and/or the base film 102 may block light from being transmitted to the photo sensor 210. According to an exemplary embodiment, as shown in FIG. 3, the end point marks 151, 153 may be printed, e.g., in a rectangular opaque mark pattern.

Referring again to FIG. 3, as the end point detection film 150 is being released from the reel body 200 due to the exhaustion of the bonding portions 101 of the die adhesive film 100, the photo sensor 200 may detect a low intensity of light and/or does not detect the light while the end point marks 151, 153 remain at a position corresponding to the photo sensor 210. When the end point detection film 150 is released from the reel body 200 such that the transparent matrix film faces the photo sensor 210, the photo sensor 200 detects a higher intensity of light. Without intending to be bound by this theory, when a light intensity variation point is set as the end point where the bonding portions 101 of the die adhesive film 100 are exhausted, the end point of the die adhesive film 100 is detected by detecting the light intensity variation between the end point marks 151, 153 and the transparent matrix film of the end point detection film 150. Embodiments are not limited there. For example, according to another exemplary embodiment, the end point marks 151, 153 may be composed of a transparent pattern and the matrix of the end point detection film 150 may be composed of an opaque pattern or a film having a different chromaticity or color from the end point marks. Thus, it may be possible to detect the difference in light transmission intensity using transparent end point marks 151, 153.

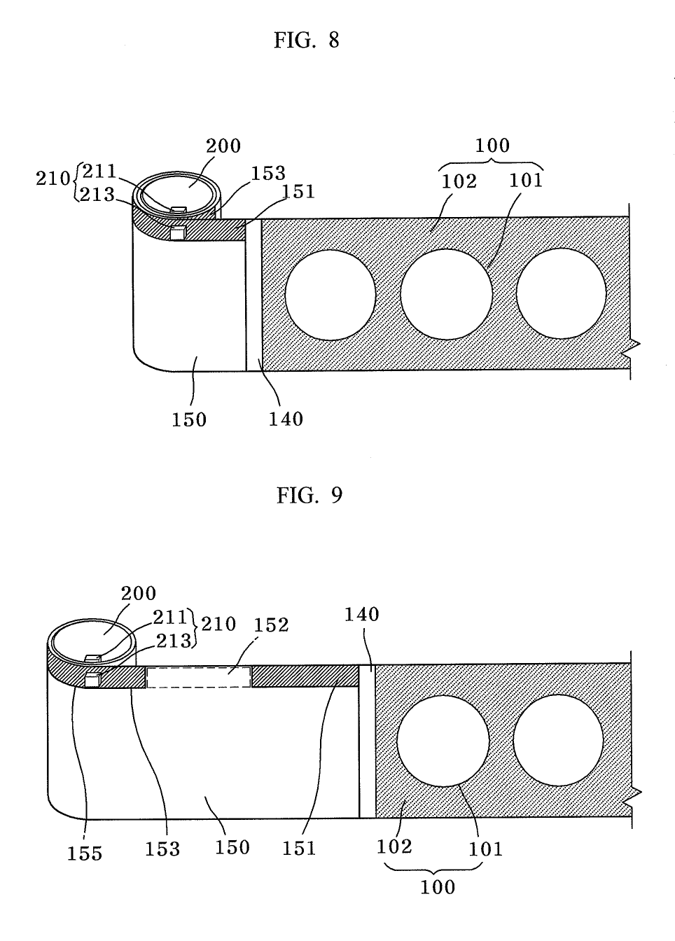

Referring to FIGS. 8 and 9, the end point marks 151, 153 may include a first mark pattern 151, a second mark pattern 152, and a third mark pattern 153. The first mark patter 151 may act as a preparatory mark and may be located near and/or adjacent to a portion of the end point detection film 150 connected to the base film 102 of the die adhesive film 100. A second mark pattern 152 may follow the first mark pattern 151 and may correspond to an exposed portion, i.e., a transparent portion, of the point detection film 150. The photo sensor 210 may detect a variation in light intensity between the first mark pattern 151 and the second mark pattern 152. The detection of the variation in light intensity may result in a first detection signal being generated. The first detection signal may be sent to the wafer supply unit 320 as a preparatory signal indicating that the bonding portions 101 of the die adhesive film 100 are nearing exhaustion.

Further, the third mark pattern 153 may be formed of an opaque pattern. The third mark pattern may follow the first and second mark patterns 151, 152. The third mark pattern 153 may be used to generate a signal detecting the end point of the die adhesive film where the die adhesive film 100 is actually exhausted. When the third mark pattern 153 is released from the reel body and passes through the photo sensor 210, a relatively low intensity of light may be detected. Then, when the third mark pattern 153 is finished and a portion 155 of the transparent end point detection film 150, e.g., a fourth mark pattern 155, is exposed to the photo sensor 210, an increased light intensity may be detected. When the light intensity variation is detected, a second detection signal may be generated. The second detection signal may be sent to the wafer supply unit 320 to indicate that the die adhesive film 100 is exhausted, so that the wafer supply unit 320 can stop the supply of the wafers in response to the second detection signal.

The first detection signal may be used as the preparatory signal of the second detection signal and/or may be detected to impart reliability for detection. In some cases, the exhaustion of the die adhesive film 100 may be detected using only the second detection signal without the first detection signal. In this case, the first mark pattern 151 need not be formed.

In consideration of a distance between the reel body 200 and a position where the wafers 300 are mounted on the bonding portions 101, the third mark pattern 153 for detecting actual exhaustion of the die adhesive film 100 may be formed to allow enough time for the second detection signal to be detected and to stop the additional supply of wafers 300. For example, the additional supply of the wafers 300 may be stopped immediately after or when the final bonding portion 101 reaches the position of mounting the wafers 300. Accordingly, a distance between the third mark pattern 153 and the position where the wafer 300 is mounted on the bonding portion 101 may be set to correspond to a distance between the reel body 200 or the photo sensor 210 and the position of mounting the wafers 300. The length of the end point detection film 150 may be set to be the same as the distance between the reel body 200 and the position of mounting the wafer 300 or to be dependent thereon. With at least one of these settings, mounting of the wafers 300 may be substantially stopped while the end point detection film 150 is released from the reel body.

Next, a process of controlling the supply of the wafers 300 depending on feeding and exhaustion of the die adhesive film 100 according to the embodiment will be described with reference to FIGS. 7 to 11.

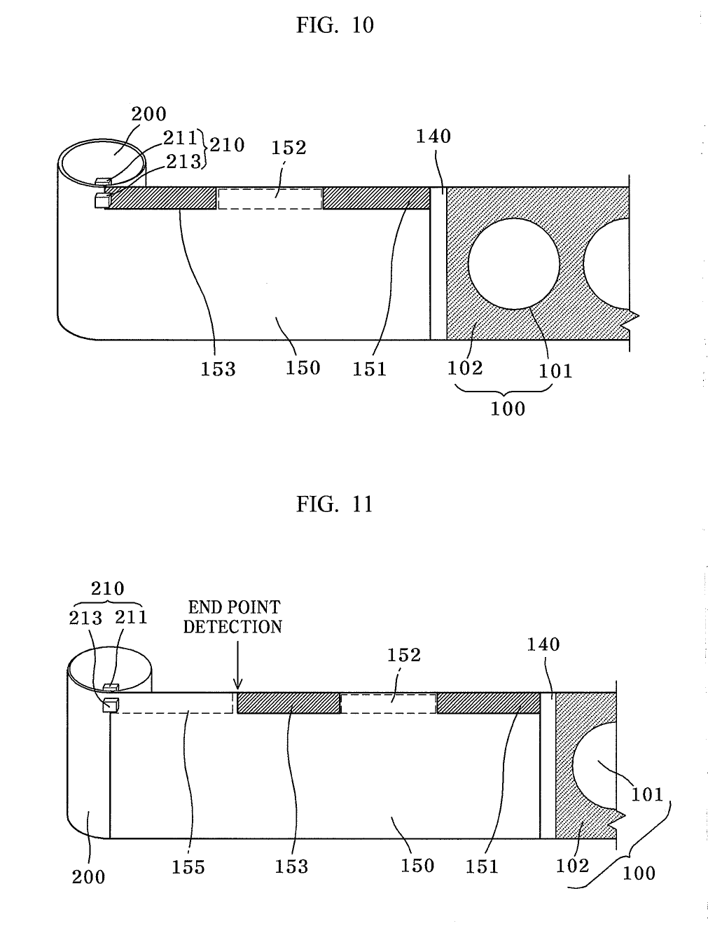

Referring to FIG. 7, when the die adhesive film 100 is initially fed to the mounting position, the end point marks 151, 153 are wound around the reel body 200. When the end point marks 151, and 153 are wound around the reel body 200, the light receiving part 213 of the photo sensor 210 may be blocked by, e.g., the base film 102, the reel body 200, and/or the end point marks 151, 153, so that a signal relating to the end point of the die adhesive film 100 may not be detected. Referring to FIG. 8, even when the end point detection film 150 is released from the reel body 200 by continuous feeding of the adhesive film 100 and continuous wafer mounting, the first mark pattern 151 may still shield the light receiving part 213 of the photo sensor 210, so that the end point signal is not generated. Referring to FIG. 9, when the second mark pattern 152 is exposed, the light receiving part 213 may no longer be shielded. Accordingly, a first detection signal due to, e.g., variation in light transmission intensity, may be generated to be used as, e.g., a preparatory signal. Referring to FIG. 10, when the third mark pattern 153 passes through the photo sensor 210 the light receiving part 213 may be shielded again. Referring to FIG. 11, after the third mark pattern 153 passes through the photo sensor 210 and the fourth mark pattern 155 is exposed to the photo sensor 210, due to a variation in, e.g., light transmission intensity, a second detection signal may be generated, e.g., a stop wafer supply signal. The second detection signal may be sent to the wafer supply unit 320 to stop additional supply of the wafers 300. Accordingly, the supply of the wafers 300 may be effectively stopped when the bonding portions 101 of the die adhesive film 100 are exhausted. Then, as shown in FIG. 11, the end point detection film 150 wound around the reel body 200 may be released from the reel body 200.

The end point detection film 150 including the end point marks 151, 153 may be formed in any pattern of continuous or discontinuous bands having a constant width along an edge of a transparent matrix, e.g., as shown in FIG. 11. For example, the end point marks 151, 153 may be merged together to form a continuous band of an opaque pattern. The end point marks 151, 153 may form discontinuous bands, e.g., the end point marks 151, 153 may be spaced apart from each other, of an opaque pattern. According to other exemplary embodiments, the end point marks 151, 153 may have a different chromaticity or different color from the transparent matrix film of the end point detection film 150. Such, that a variation in light transmission intensity and/or light transmission degree may be detected by the photo sensor 210.

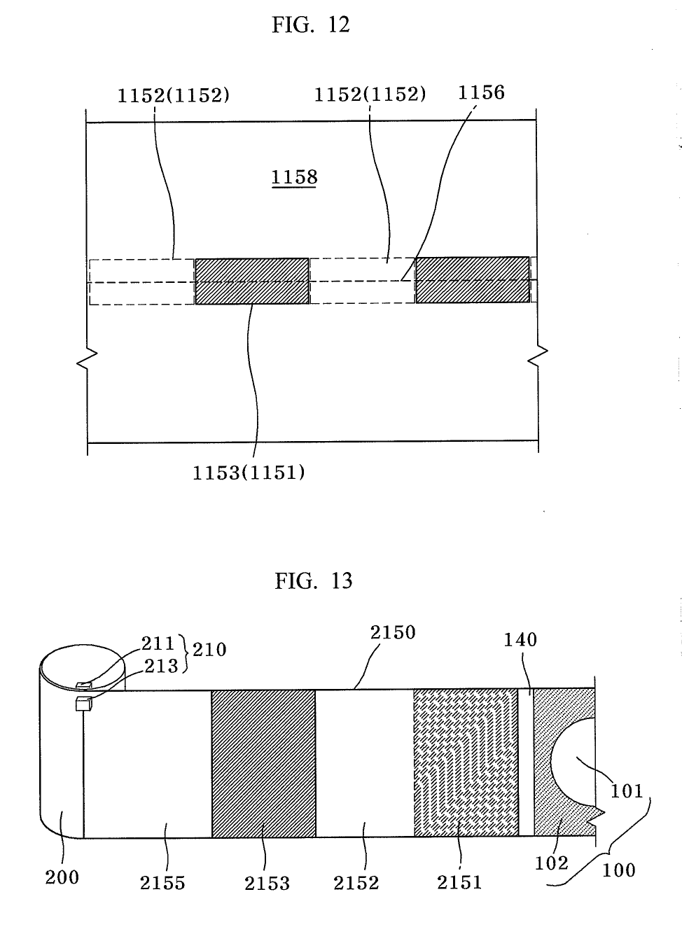

Referring to FIG. 12, preparation mark patterns 1151, 1153 may be intermittently printed along a centerline 1156 of a preparation film 1158. A width of preparation mark patterns 1151, 1153 may be two times that of the end point marks 151, 153 of the end point detection film 150. The printed patterns may have a color, e.g., red or blue. Sections 1152 between the preparation mark patterns 1153, 1151 may correspond to the second mark pattern 152 or the fourth mark pattern 155 in the end point detection film 150. The preparation film 1158 may be cut along the centerline 1156, to form the end point detection film 150 shown in FIG. 11. The end point detection film 150 may then be connected to the die adhesive film 100 and wound around the reel body 200. Each of the end point marks 151, 153 may be formed to have, e.g., a continuous band shape.

Each of the end point marks 151, 153 according to an exemplary embodiment may have a width greater than an outer circumference or diameter of the reel body 200. The end point marks 151 may be located adjacent to a portion of the end point detection film 150 adjacent to the base film 102, and the end point mark 153 may be located near a centerline of the end point detection film 150. Each end point marks 151, 153 may be wound at least once around the entire reel body 200. Accordingly, the possibility of an error in light detection of the photo sensor 210 may be reduced and/or prevented. Each of the end point marks 151, 153 may have a width that is determined in consideration of the wavelength of light detected by the photo sensor 210. For example, the end point marks 151, 153 may have a width of about 50 mm, a length of about 540 mm, and a distance of about 540 mm therebetween. The entire length of the end point detection film 150 may be set to, e.g., 1180 mm.

The end point 151, 153 may be modified as shown in FIG. 13. In this modification, a first mark pattern 2151 and a third mark pattern 2153 may be formed to have a width sufficient to cover the entire width of an end point detection film 2150, so that a second mark pattern 2152 and a fourth mark pattern 2155 may also be increased in width, e.g., have a width equal the width of the first mark pattern 2151 and third mark pattern 2153. Further, the first mark pattern 2151 may also be omitted in this modification.

Although the die adhesive film of the embodiment is illustrated as being used to bond the semiconductor wafers in the above description, it should be understood that the die adhesive film of the embodiment may also be applied to other electronic devices. For example, an electronic device such as an LED or an integrated circuit device may be bonded to the bonding portions on the base film of the die adhesive film.

By way of summation and review, the die adhesive film may be consecutively fed to a mounting position where the die adhesive film is bonded to wafers. However, absent what is disclosed herein, wafers may continue to be provided to the mounting position when feeding of the die adhesive film is stopped, e.g., because the die adhesive film is exhausted. As such, when a die adhesive film is not provided to the surfaces of the wafers, a stoppage of the overall process and/or damage of the wafers may occur. For example, an exemplary die adhesive film wound around a single reel may include a plurality of bonding portions which may be bonded to, e.g., about 300 wafers. However, even after the die adhesive film is completely fed from the reel, the wafers may continue to be supplied to the mounting position due to difficulty in detection of the exhaustion of the die adhesive film. By contrast, the embodiments provides a technique that can detect an end point at which the die adhesive film is exhausted in the context of a die adhesive film, a reel for a die adhesive film, a mounting apparatus including a die adhesive film, and an electronic device including a die adhesive film.

Exemplary embodiments have been disclosed herein. Although some embodiments have been provided to illustrate the invention in conjunction with the drawings, it will be apparent to those skilled in the art that the embodiments are given by way of illustration only, and that that various modifications, changes, alterations, and equivalent embodiments can be made without departing from the spirit and scope of the present invention. Further, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A die adhesive film for bonding to wafers, the film comprising:
a base film including bonding portions, the bonding portions being arranged in a series on the base film and being capable of being bonded to surfaces of the wafers; and
an end point detection film including an end connected to the base film and having at least one end point mark for indicating an end point of the bonding portions on the base film at which the series of bonding portions on the base film is finished.

2. The film as claimed in claim 1, wherein each of the bonding portions includes:
an adhesive film attached to the base film, the adhesive film being capable of being bonded to the surface of the corresponding wafer;
a dicing film disposed on the adhesive film, the dicing film being configured to have attached thereto a ring frame on a rim of the wafer bonded to the adhesive film.

3. The film as claimed in claim 1, wherein the end point detection film includes a transparent matrix film, and the at least one end point mark is printed on the transparent matrix film, the at least one end point mark being an opaque pattern, a pattern having a different chromaticity from the transparent matrix film, or a pattern having a different color from the transparent matrix film.

4. The film as claimed in claim 3, wherein the at least one end point mark includes:
a first mark pattern adjacent to a portion of the transparent matrix film connected to the base film; and
a second mark pattern spaced apart by a predetermined distance from the first mark pattern and disposed near a centerline of the transparent matrix film.

5. The film as claimed in claim 3, wherein the at least one end point mark is a pattern of continuous or discontinuous bands having a constant width and biased toward an edge of the transparent matrix film, or the at least one end point mark is a pattern of continuous or discontinuous bands having a same width as the transparent matrix film.

6. A reel for a die adhesive film used for bonding to wafers, the die adhesive film including a base film and an end point detection film, the reel for a die adhesive film comprising:
a reel body having the die adhesive film wound thereon; and
a mark detector configured to detect at least one end point mark of the end point detection film, wherein:
the base film includes bonding portions, the bonding portions being arranged in a series on the base film and being capable of being bonded to surfaces of the wafers;
the end point detection film includes an end connected to the base film and has at least one end point mark for indicating an end point of the bonding portions on the base film at which the series of bonding portions on the base film is finished; and
the mark detector is configured to recognize the end point of the bonding portions.

7. The reel for the die adhesive film as claimed in claim 6, wherein the end point detection film includes a transparent matrix film, and the at least one end point mark is printed on the transparent matrix film, the at least one end point mark being an opaque pattern, a pattern having a different chromaticity from the transparent matrix film, or a pattern having a different color from the transparent matrix film.

8. The reel for the die adhesive film as claimed in claim 7, wherein the at least one end point mark includes:
a first mark pattern adjacent to a portion of the transparent matrix film connected to the base film; and
a second mark pattern spaced apart by a predetermined distance from the first mark pattern and disposed near a centerline of the transparent matrix film.

9. The reel for the die adhesive film as claimed in claim 8, wherein the mark detector includes a photo sensor configured to detect the end point of the bonding portions based on a difference between a first light transmission intensity at the second mark pattern and a second light transmission intensity at a portion of the transparent matrix film following the second mark pattern.

10. The reel for a die adhesive film as claimed in claim 7, wherein the at least one end point mark is a pattern of continuous or discontinuous bands having a constant width and biased toward an edge of the transparent matrix film, or the at least one end point mark is a pattern of continuous or discontinuous bands having a same width as the transparent matrix film.

11. The reel for a die adhesive film as claimed in claim 6, wherein the at least one end point mark is printed in a pattern having a width in a longitudinal direction of the transparent matrix film that is greater than an outer circumference of the reel body.

12. The reel for a die adhesive film as claimed in claim 6, wherein the mark detector includes a photo sensor coupled to the reel body, the photo sensor having a light emitting part and a light receiving part configured to detect a difference in light transmission intensity between the at least one end point mark and a portion of the end point detection film adjacent to the end point mark.

13. A mounting apparatus, comprising:
a die adhesive film, the die adhesive film including:
a base film including bonding portions, the bonding portions being arranged in a series on the base film and being capable of being bonded to surfaces of wafers; and
an end point detection film including an end connected to the base film and having at least one end point mark for indicating an end point of the bonding portions on the base film at which the series of bonding portions on the base film is finished;
a reel for the die adhesive film, the reel including:
a reel body having the die adhesive film wound thereon; and
a mark detector configured to detect the at least one end point mark of the end point detection film and to recognize the end point of the bonding portions; and
a wafer supply unit configured to sequentially supply the wafers to be bonded to each of the bonding portions of the die adhesive film released and fed from the reel body, the wafer supply unit being configured to stop the supply of the wafers in response to a signal from the mark detector detecting the end point of the bonding portions.

14. The mounting apparatus as claimed in claim 13, wherein:
each of the bonding portions includes an adhesive film attached to the base film, the adhesive film being capable of being bonded to the surface of the corresponding wafer, and includes a dicing film disposed on the adhesive film, the dicing film being configured to have attached thereto a ring frame on a rim of the wafer bonded to the adhesive film, and
the wafer supply unit is configured to supply the wafers for attaching to the adhesive film after the base film is stripped and the adhesive film exposed.

15. The mounting apparatus as claimed in claim 13, wherein the end point detection film has a same length as a distance between the reel body and a position of the mounting apparatus at which the wafers are attached to the bonding portions such that supply of the wafers is stopped when the end point of the bonding portions is detected.

16. The mounting apparatus as claimed in claim 13, wherein:
the end point detection film includes a first mark pattern adjacent to portion of the transparent matrix film connected to the base film and includes a second mark pattern spaced apart by a predetermined distance from the first mark pattern and disposed near a centerline of the transparent matrix film, and
the mark detector includes a photo sensor configured to detect the end point of the bonding portions based on a difference between a first light transmission intensity at the second mark pattern and a second light transmission intensity at a portion of the transparent matrix film following the second mark pattern.

17. The mounting apparatus as claimed in claim 13, wherein the mark detector includes a photo sensor coupled to the reel body, the photo sensor having a light emitting part and a light receiving part configured to detect a difference in light transmission intensity between the at least one end point mark and a portion of the end point detection film adjacent to the end point mark.

18. The mounting apparatus as claimed in claim 13, wherein the mark detector includes a photo sensor coupled to the reel body and having a light emitting part and a light receiving part, wherein:
the light receiving part is configured to generate a preparatory signal when a first difference in light transmission intensity between a first end point mark and a portion of the end point detection film adjacent to the first end point mark is detected;
the light receiving part is configured to generate an end point detection signal when a second difference in light transmission intensity between a second end point mark and a portion of the end point detection film adjacent to the second end point mark is detected; and
the wafer supply unit is configured to stop the supply of the wafers in response to the end point detection signal.

19. An electronic product comprising the die adhesive film as claimed in claim 1.

20. An electronic product, comprising:
an electronic device; and
a die adhesive film,
the die adhesive film including:
a base film including bonding portions, the bonding portions being arranged in a series on the base film and being capable of being bonded to surfaces of the wafers; and
an end point detection film including an end connected to the base film and having at least one end point mark for indicating an end point of the bonding portions on the base film at which the series of bonding portions on the base film is finished.
